(19) United States
(12) Patent Application Publication
(10) Pub. No.: US 2013/0177084 A1
(43) Pub. Date: Jul. 11, 2013

(54) MOTION VECTOR SCALING IN VIDEO CODING

(71) Applicant: QUALCOMM Incorporated, San Diego, CA (US)

(72) Inventors: Ye-Kui Wang, San Diego, CA (US); Xianglin Wang, San Diego, CA (US)

(73) Assignee: QUALCOMM INCORPORATED, San Diego, CA (US)

(21) Appl. No.: 13/736,734

(22) Filed: Jan. 8, 2013

Related U.S. Application Data
(60) Provisional application No. 61/585,001, filed on Jan. 10, 2012.

(51) Int. Cl. H04N 7/26

(52) U.S. Cl. CPC H04N 19/00684
USPC 375/240.16

(57) ABSTRACT

This disclosure proposes techniques for motion vector scaling. In particular, this disclosure proposes that both an implicit motion vector scaling process (e.g., the POC-based motion vector scaling process described above), as well as an explicit motion vector (e.g., a motion vector scaling process using scaling weights) may be used to perform motion vector scaling. This disclosure also discloses example signaling methods for indicating the type of motion vector scaling used.

### RELATED APPLICATIONS

This application claims the benefit of U.S. Provisional Application No. 61/585,001, filed Jan. 10, 2012, the content of which are hereby incorporated by reference in its entirety.

### TECHNICAL FIELD

This disclosure relates to video coding, and more particularly to techniques for motion vector scaling in an inter-prediction process.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences. For block-based video coding, a video frame or slice may be partitioned into blocks. A video frame alternatively may be referred to as a picture. Each block can be further partitioned. Blocks in an intra-coded (I) frame or slice are encoded using spatial prediction with respect to reference samples in neighboring blocks in the same frame or slice. Blocks in an inter-coded (P or B) frame or slice may use spatial prediction with respect to reference samples in neighboring blocks in the same frame or slice or temporal prediction with respect to reference samples in other reference frames. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in a particular order to produce a one-dimensional vector of transform coefficients for entropy coding.

### SUMMARY

In general, this disclosure describes techniques for coding video data. In particular, this disclosure describes techniques for motion vector scaling (including generation of motion vector scaling weights) and signaling of control information for motion vector scaling for use in an inter-prediction video coding process.

In one example of the disclosure, a method of decoding a motion vector comprises receiving an index indicating a motion vector, receiving one or more flags indicating a motion vector scaling process used to scale the motion vector, and scaling the motion vector using one of a plurality of different motion vector scaling processes.

In another example of this disclosure, a method of encoding a motion vector comprises scaling a motion vector using one of a plurality of different motion vector scaling processes, and signaling one or more flags indicating the motion vector scaling process used to scale the motion vector.

This disclosure also describes video encoder, video decoder, apparatuses, and computer-readable mediums storing instructions that may be configured to perform the techniques for motion vector scaling described herein.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system.

FIG. 2 is a conceptual illustrating showing candidate blocks for motion vector prediction.

FIG. 3 is a conceptual diagram illustrating an example motion vector scaling process.

FIG. 4 is a block diagram illustrating an example video encoder configured to perform the techniques of this disclosure.

FIG. 5 is a block diagram illustrating an example motion estimation unit of a video encoder configured to perform the techniques of this disclosure.

FIG. 6 is a block diagram illustrating an example video decoder configured to perform the techniques of this disclosure.

FIG. 7 is a block diagram illustrating an example motion compensation unit of a video decoder configured to perform the techniques of this disclosure.

FIG. 8 is a flowchart of an example decoding method according to the techniques of this disclosure.

FIG. 9 is a flowchart of an example encoding method according to the techniques of this disclosure.

### DETAILED DESCRIPTION

In general, this disclosure describes techniques for coding video data. In the examples detailed below, this disclosure describes techniques for performing motion vector scaling in a video encoding and/or decoding process.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

In addition, there is a new video coding standard, namely High-Efficiency Video Coding (HEVC), being developed by the Joint Collaboration Team on Video Coding (JCT-VC) of ITU-T Video Coding Experts Group (VCEG) and ISO/IEC Motion Picture Experts Group (MPEG). One working draft (WD) of the HEVC specification is described in document JCTVC-G1003, Bross et al., “High efficiency video coding (HEVC) text specification draft 5,” Joint Collaborative Team on Video Coding (JCT-VC) of ITU-T SG16 WP3 and ISO/IEC JTC1/SC29/WG11 (referred to as HEVC WD5 hereinafter) is available from http://phenix.int-evry.fr/jct/doc_end_user/documents/7_Geneva/wg11/JCTVC-G1103-v3.zip. Another, more recent working draft of the HEVC specification is described in document JCTVC-11003, Bross et al., “High efficiency video coding (HEVC) text specification draft 9,” Joint Collaborative Team on Video Coding (JCT-VC) of ITU-T SG16 WP3 and ISO/IEC JTC1/SC29/WG11, and referred to as HEVC WD9 hereinafter, is available from http://phenix.int-evry.fr/jct/doc_end_user/documents/11_Shanghai/wg11/JCTVC-K1003-v12.zip.

The techniques of this disclosure will be generally described with relation to the emerging HEVC standard. However, the techniques of this disclosure may be applicable for use with other video coding technologies, including non-standard video codecs and other standard video codecs, including any of the aforementioned video coding standards, as well as with any future standards or future extensions of the aforementioned standards.

Digital video devices implement video compression techniques to encode and decode digital video information more efficiently. Video compression may apply spatial (intra-frame) prediction (intra prediction) and/or temporal (inter-frame) prediction (inter prediction) techniques to reduce or remove redundancy inherent in video sequences.

Inter prediction, makes use of similarities in a video image between different frames of the video. When coding a current block in a current frame using inter prediction, a motion estimation process is first performed to find a matching, or closely matching block in a temporally previous and/or subsequent frame (i.e., the reference frame). A motion vector is then computed that points to the position of the matching block in the reference frame. This motion vector, along with a calculated difference (residual) between pixels in the current block of video data in the current frame and pixels in the matching block in the reference frame, is used to code the current block.

In some video coding techniques, rather than signal the motion vector for a currently coded block, a motion vector prediction technique is used instead. One motion vector prediction technique is called advanced motion vector prediction (AMVP). In AMVP, the motion vector associated with one or more candidate blocks that neighbor the currently coded block (or candidate blocks in another temporal frame is used as the motion vector for the current block. The difference between the motion vector determined through the motion search process and the motion vector of the candidate block is then determined, i.e., the motion vector difference (MVD). The MVD along with an index indicating the candidate bock within a list of candidate blocks are signaled to indicate the motion vector of the current block. In this way, the amount of information needed to signal a motion vector for a block of video data is reduced. In addition, for AMVP, the reference index and the prediction direction may also be signaled.

In some instances, it may be desirable to scale the motion vector of the chosen candidate block to improve video quality and/or coding efficiency. As one example, motion vectors may be scaled to meet certain range limits on the size of the motion vector indicated by a specific video coding level and/or profile. In some examples, motion vector scaling is performed when the reference frame pointed to by the motion vector determined through the motion search process is different from the reference frame pointed to by the candidate motion vector.

Existing designs for motion vector scaling exhibit several drawbacks. As one example, in some video coding techniques, motion vector scaling is not performed when a reference picture is marked as a long-term reference. However, any reference picture may be marked as a long-term reference picture. Thus, it is possible that motion vector scaling is still beneficial in some cases when a long-term reference picture is involved. In other video coding proposals, motion vector scaling is performed unless the picture order count (POC) distance between the reference picture of the current prediction unit (PU) and the reference picture of the candidate PU (collocated PU or neighbor PU) is larger than a pre-defined threshold, e.g., indicating a larger temporal distance. However, while a pre-defined temporal distance threshold may be optimal for certain video sequences, it may be sub-optimal for other video sequences.

In view of these drawbacks, this disclosure proposes techniques for motion vector scaling. In one example of the disclosure, a video encoding technique may include scaling a motion vector using one of a plurality of different motion vector scaling processes, and signaling one or more flags indicating the motion vector scaling process used to scale the motion vector. Likewise, in another example of the disclosure, a video decoding technique may include receiving one or more flags indicating a motion vector scaling process used to scale the motion vector, and scaling a motion vector based on the received one or more flags. The different motion vector scaling processes may include an implicit, POC-based scaling process, and an explicit scaling process, wherein scaling weights are also signaled. In this way, motion vector scaling may be selectively applied and signaled, even in cases where a large POC distance and/or the use of a long-term reference picture are present.

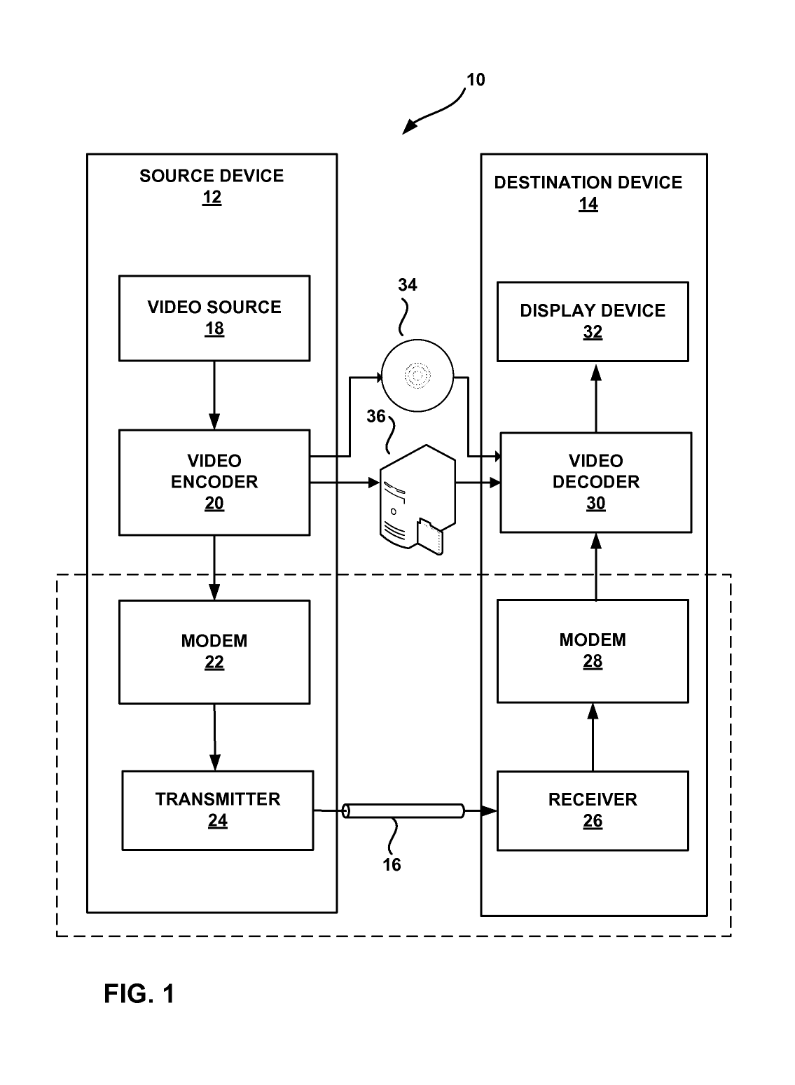

FIG. 1 is a block diagram illustrating an example video encoding and decoding system 10 that may be configured to utilize techniques for motion vector scaling in accordance with examples of this disclosure. As shown in FIG. 1, the system 10 includes a source device 12 that transmits encoded video to a destination device 14 via a communication channel 16. Encoded video data may also be stored on a storage medium 34 or a file server 36 and may be accessed by the destination device 14 as desired. When stored to a storage medium or file server, the video encoder 20 may provide coded video data to another device, such as a network interface, a compact disc (CD), Blu-ray or digital video disc (DVD) burner or stamping facility device, or other devices, for storing the coded video data to the storage medium. Likewise, a device separate from video decoder 30, such as a network interface, CD or DVD reader, or the like, may retrieve coded video data from a storage medium and provided the retrieved data to video decoder 30.

The source device 12 and the destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In many cases, such devices may be equipped for wireless communication. Hence, the communication channel 16 may comprise a wireless channel, a wired channel, or a combination of wireless and wired channels suitable for transmission of encoded video data. Similarly, the file server 36 may be accessed by the destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server.

Techniques for motion vector prediction, in accordance with examples of this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, the system 10 may be configured to support one-way or two-way video transmission to support applications such as video streaming, video playback, video broadcasting, and/or video telephony.

In the example of FIG. 1, the source device 12 includes a video source 18, a video encoder 20, a modulator/demodulator 22 and a transmitter 24. In the source device 12, the video source 18 may include a source such as a video capture device, such as a video camera, a video archive containing previously captured video, a video feed interface to receive video from a video content provider, and/or a computer graphics system for generating computer graphics data as the source video, or a combination of such sources. As one example, if the video source 18 is a video camera, the source device 12 and the destination device 14 may form so-called camera phones or video phones. However, the techniques described in this disclosure may be applicable to video coding in general, and may be applied to wireless and/or wired applications, or application in which encoded video data is stored on a local disk.

The captured, pre-captured, or computer-generated video may be encoded by the video encoder 20. The encoded video information may be modulated by the modem 22 according to a communication standard, such as a wireless communication protocol, and transmitted to the destination device 14 via the transmitter 24. The modem 22 may include various mixers, filters, amplifiers or other components designed for signal modulation. The transmitter 24 may include circuits designed for transmitting data, including amplifiers, filters, and one or more antennas.

The captured, pre-captured, or computer-generated video that is encoded by the video encoder 20 may also be stored onto a storage medium 34 or a file server 36 for later consumption. The storage medium 34 may include Blu-ray discs, DVDs, CD-ROMs, flash memory, or any other suitable digital storage media for storing encoded video. The encoded video stored on the storage medium 34 may then be accessed by the destination device 14 for decoding and playback.

The file server 36 may be any type of server capable of storing encoded video and transmitting that encoded video to the destination device 14. Example file servers include a web server (e.g., for a website), an FTP server, network attached storage (NAS) devices, a local disk drive, or any other type of device capable of storing encoded video data and transmitting it to a destination device. The transmission of encoded video data from the file server 36 may be a streaming transmission, a download transmission, or a combination of both. The file server 36 may be accessed by the destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on a file server.

The destination device 14, in the example of FIG. 1, includes a receiver 26, a modem 28, a video decoder 30, and a display device 32. The receiver 26 of the destination device 14 receives information over the channel 16, and the modem 28 demodulates the information to produce a demodulated bitstream for the video decoder 30. The information communicated over the channel 16 may include a variety of syntax information generated by the video encoder 20 for use by the video decoder 30 in decoding video data. Such syntax may also be included with the encoded video data stored on the storage medium 34 or the file server 36. Each of the video encoder 20 and the video decoder 30 may form part of a respective encoder-decoder (CODEC) that is capable of encoding or decoding video data.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In the example of FIG. 1, the communication channel 16 may comprise any wireless or wired communication medium, such as a radio frequency (RF) spectrum or one or more physical transmission lines, or any combination of wireless and wired media. The communication channel 16 may form part of a packet-based network, such as a local area network, a wide-area network, or a global network such as the Internet. The communication channel 16 generally represents any suitable communication medium, or collection of different communication media, for transmitting video data from the source device 12 to the destination device 14, including any suitable combination of wired or wireless media. The communication channel 16 may include routers, switches, base stations, or any other equipment that may be useful to facilitate communication from the source device 12 to the destination device 14.

The video encoder 20 and the video decoder 30 may operate according to a video compression standard, such as the High Efficiency Video Coding (HEVC) standard presently under development, and may conform to the HEVC Test Model (HM). Alternatively, the video encoder 20 and the video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples include MPEG-2 and ITU-T H.263.

Although not shown in FIG. 1, in some aspects, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

The video encoder 20 may implement any or all of the techniques of this disclosure for motion vector prediction in a video encoding process. Likewise, the video decoder 30 may implement any or all of these techniques motion vector prediction in a video coding process. A video coder, as described in this disclosure, may refer to a video encoder or a video decoder. Similarly, a video coding unit may refer to a video encoder or a video decoder. Likewise, video coding may refer to video encoding or video decoding.

As will be described in more detail below, video decoder 30 may configured to receive an index indicating a motion vector, receive one or more flags indicating a motion vector scaling process used to scale the motion vector, and scale the motion vector using one of a plurality of different motion vector scaling processes. Video encoder 20 may be configured to scale a motion vector using one of a plurality of different motion vector scaling processes, and signal one or more flags indicating the motion vector scaling process used to scale the motion vector.

For video coding according to the HEVC standard currently under development. as one example, a video frame may be partitioned into coding units. A coding unit (CU) generally refers to an image region that serves as a basic unit to which various coding tools are applied for video compression. A CU usually has a luminance component, denoted as Y, and two chroma components, denoted as U and V. Depending on the video sampling format, the size of the U and V components, in terms of number of samples, may be the same as or different from the size of the Y component. A CU is typically square, and may be considered to be similar to a so-called macroblock, e.g., under other video coding standards such as ITU-T H.264. Coding according to some of the presently proposed aspects of the developing HEVC standard will be described in this application for purposes of illustration. However, the techniques described in this disclosure may be useful for other video coding processes, such as those defined according to H.264 or other standard or proprietary video coding processes.

HEVC standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-four intra-prediction encoding modes.

According to the HM, a CU may include one or more prediction units (PUs) and/or one or more transform units (TUs). Syntax data within a bitstream may define a largest coding unit (LCU), which is a largest CU in terms of the number of pixels. In general, a CU has a similar purpose to a macroblock of H.264, except that a CU does not have a size distinction. Thus, a CU may be split into sub-CUs. In general, references in this disclosure to a CU may refer to a largest coding unit of a picture or a sub-CU of an LCU. An LCU may be split into sub-CUs, and each sub-CU may be further split into sub-CUs. Syntax data for a bitstream may define a maximum number of times an LCU may be split, referred to as CU depth. Accordingly, a bitstream may also define a smallest coding unit (SCU). This disclosure also uses the term “block” or “portion” to refer to any of a CU, PU, or TU. In general, “portion” may refer to any sub-set of a video frame.

An LCU may be associated with a quadtree data structure. In general, a quadtree data structure includes one node per CU, where a root node corresponds to the LCU. If a CU is split into four sub-CUs, the node corresponding to the CU includes four leaf nodes, each of which corresponds to one of the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, 4 sub-CUs of a leaf-CU will also be referred to as leaf-CUs although there is no explicit splitting of the original leaf-CU. For example if a CU at 16×16 size is not split further, the four 8×8 sub-CUs will also be referred to as leaf-CUs although the 16×16 CU was never split.

Moreover, TUs of leaf-CUs may also be associated with respective quadtree data structures. That is, a leaf-CU may include a quadtree indicating how the leaf-CU is partitioned into TUs. This disclosure refers to the quadtree indicating how an LCU is partitioned as a CU quadtree and the quadtree indicating how a leaf-CU is partitioned into TUs as a TU quadtree. The root node of a TU quadtree generally corresponds to a leaf-CU, while the root node of a CU quadtree generally corresponds to an LCU. TUs of the TU quadtree that are not split are referred to as leaf-TUs.

A leaf-CU may include one or more prediction units (PUs). In general, a PU represents all or a portion of the corresponding CU, and may include data for retrieving a reference sample for the PU. For example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the leaf-CU defining the PU(s) may also describe, for example, partitioning of the CU into one or more PUs. Partitioning modes may differ depending on whether the CU is uncoded, intra-prediction mode encoded, or inter-prediction mode encoded. For intra coding, a PU may be treated the same as a leaf transform unit described below.

An encoder may perform a process commonly referred to as “motion estimation” to determine a motion vector for each resulting block (e.g., a PU) formed after splitting the sub-CU. The encoder determines these motion vectors by, as one example, performing what may be referred to as a “motion search” in a reference frame, where the encoder searches for each block in either a temporally subsequent or future reference frame. Upon finding a portion of the reference frame (that could be an interpolated portion) that best matches the current block, the encoder determines the current motion vector for the current block as the difference in the location from the current block to the matching portion in the reference frame (i.e., from the center of the current block to the center of the matching portion).

In some examples, an encoder may signal the motion vector for each block in the encoded video bitstream. The signaled motion vector is used by the decoder to perform motion compensation in order to decode the video data. However, signaling the entire motion vector may result in less efficient coding, as the motion vectors are typically represented by a large number of bits.

In some instances, rather than signal the entire motion vector, the encoder may predict a motion vector for each partition. In performing this motion vector prediction, the encoder may select a set of candidate motion vectors determined for spatially neighboring PUs in the same frame as the current block or a candidate motion vector determined for a co-located PU in another reference frame. The encoder may perform motion vector prediction rather than signal an entire motion vector to reduce complexity and bit rate in signaling.

Two different modes or types of motion vector prediction are currently proposed for use in HEVC. One mode is referred to as a “merge” mode. The other mode is referred to as adaptive motion vector prediction (AMVP). In merge mode, the encoder instructs a decoder, through bitstream signaling of prediction syntax, to copy a motion vector, reference index (identifying a reference frame, in a given reference picture list, to which the motion vector points) and the motion prediction direction (which identifies the reference picture list, i.e., in terms of whether the reference frame temporally precedes or follows the currently frame) from a selected candidate motion vector (the motion vector predictor or “MVP”) for a current block of the frame. This is accomplished by signaling in the bitstream an index identifying the candidate block having the selected candidate motion vector, i.e., among a list of candidate blocks. Thus, for merge mode, the prediction syntax may include a flag identifying the mode (in this case “merge” mode) and an index identifying the location of the candidate block. In some instances, the candidate block will be a causal block in reference to the current block. That is, the candidate block will have already been decoded by the decoder. As such, the decoder has already received and/or determined the motion vector, reference index, and motion prediction direction for the candidate block. As such, the decoder may simply retrieve the motion information for the candidate block, i.e., the motion vector, reference index, and motion prediction direction associated with the candidate block from memory and copy these values for the current block.

In AMVP mode, the encoder instructs the decoder, through bitstream signaling, to only copy the motion vector (the MVP) from the candidate block, and signals the reference frame and the prediction direction separately. In AMVP mode, the motion vector to be copied may be signaled by sending an index identifying the candidate block having selected candidate motion vector, i.e., among a list of candidate blocks, and a motion vector difference (MVD). An MVD is the difference between the current motion vector for the current block and a candidate motion vector for a candidate block. In this way, the decoder need not use an exact copy of the candidate motion vector for the current motion vector, but may rather use a candidate motion vector that is “close” in value to the current motion vector and add the MVD to reproduce the current motion vector.

In most circumstances, the MVD requires fewer bits to signal than the entire current motion vector. As such, AMVP mode allows for more precise signaling of the current motion vector while maintaining coding efficiency over sending the whole motion vector. In contrast, the merge mode does not allow for the specification of an MVD, and as such, merge mode sacrifices accuracy of motion vector signaling for increased signaling efficiency (i.e., fewer bits). The prediction syntax for AMVP mode may include a flag for the mode (in this case AMVP mode), the index for the candidate block, the MVD between the current motion vector and the candidate motion vector for the candidate block, the reference index, and the motion prediction direction. AMVP mode may select a candidate block in a similar fashion as to that of merge mode.

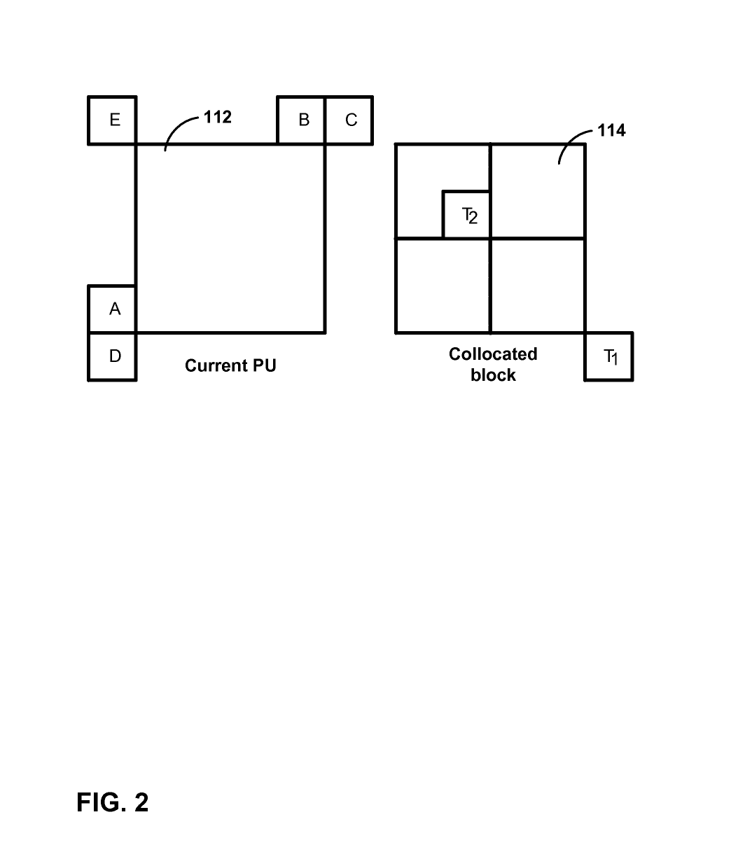

FIG. 2 is a conceptual diagram illustrating spatial and temporal neighboring blocks from which motion vector predictor candidates are generated for motion vector prediction modes. In one example proposal for HEVC, both merge and AMVP mode uses the same motion vector predictor candidate list from which to determine a motion vector for a current video block or PU 112. The motion vector predictor candidates in the merge mode and AMVP mode may include motion vectors for spatial neighboring blocks of current PU 112, for example, neighboring blocks A, B, C, D and E illustrated in FIG. 2. The motion vector predictor candidates may also include motion vectors for temporal neighboring blocks of a collocated block 114 of current PU 112, for example, neighboring blocks T₁ and T₂ illustrated in FIG. 2. A collocated block is a block in a different picture than the currently coded block. In some cases, the motion vector predictor candidates may include combinations of motion vectors for two or more of the neighboring blocks, e.g., an average, median, or weighted average of the two or more motion vectors.

Once motion estimation is performed to determine a motion vector for each of the blocks, the encoder compares the matching portion in the reference frame (if a motion search was performed) or the portion of the reference frame identified by the predicted motion vector (if motion vector prediction was performed) to the current block. This comparison typically involves subtracting the portion (which is commonly referred to as a “reference sample”) in the reference frame from the current block and results in so-called residual data. The residual data indicates pixel difference values between the current block and the reference sample. The encoder then transforms this residual data from the spatial domain to the frequency domain. Usually, the encoder applies a discrete cosine transform (DCT) to the residual data to accomplish this transformation. The encoder performs this transformation in order to further compress the residual data as the resulting transform coefficients need only be encoded after the transformation rather than the residual data in its entirety.

After performing lossless statistical coding, the encoder generates a bitstream that includes the encoded video data. This bitstream also includes a number of prediction syntax elements in certain instances that specify whether, for example, motion vector prediction was performed, the motion vector mode, and a motion vector predictor (MVP) index (i.e., the index of the candidate block with the selected motion vector). The MVP index may also be referred to as its syntax element variable name “mvp_idx.”

As described above, in some instances, a motion vector (e.g., a motion vector of a candidate block) may first be scaled, e.g., to derive the motion vector predictor (MVP). As one example, motion vectors may be scaled to meet certain range limits on the size of the motion vector indicated by a specific video coding level and/or profile. The motion vector scaling process for MVP derivation in HEVC WD5 is described below.

When an MVP is derived from a motion vector from a candidate block (i.e., the candidate motion vector) pointing to a different reference picture than the motion vector found for the current block in the motion search, the candidate motion vector is scaled to the target reference picture as the final MVP. In the motion vector scaling process, the scaling factor DistScaleFactor is defined by:

DistScaleFactor=(POC_{curr}−POC_{ref})/(POCₘᵥₚ_{_{—}}_{blk}_{_{—}}−POCₘᵥₚ_{_{—}}_{blk}_{_{—}}_{ref})=tb/td (1)

POC stands for picture order count. POC_{curr} is the POC for the current block to be coded. POC_{ref} is the POC for the reference block of the current block (i.e., the reference block of the motion vector for the current block found during the motion search). POCₘᵥₚ_{_{—}}_{blk} is the POC for the candidate block having the MVP, which is denoted as MVP_BLK. POCₘᵥₚ_{_{—}}_{blk}_{_{—}}_{ref} is the POC for the reference block of the block MVP_BLK. The variable td is the POC distance between the block MVP_BLK and its reference block, and tb is the POC distance between the current block and its reference block. According to the current HEVC, the scaling factor DistScaleFactor is calculated with integer operation by the following equations:

tx=(16384+Abs(td/2))/td (2)

DistScaleFactor=Clip3(−4096,4095,(tb*tx+32)>>6) (3)

DistScaleFactor may therefore be computed as a function of tb and tx, but clipped to be within a range of −4096 and 4095, as one example. Using this DistScaleFactor, a video coder may scale one or more of the candidate motion vectors in accordance with the following equation (4):

ScaledMV=sign(DistScaleFactor×MV)×((abs(DistScaleFactor×MV)+127))>>8) (4)

ScaledMV denotes a scaled candidate motion vector, MV is the motion vector, “sign” refers to a function that keeps signs, “abs” refers to a function that computes the absolute value of the value and “>>” denotes a bit-wise right shift.

In some examples, both a vertical component and a horizontal component of a motion vector may be scaled. In other examples, it may be desirable to scale only one component (e.g., just the vertical component or just the horizontal component). In other circumstances, both components of the motion vector may be scaled.

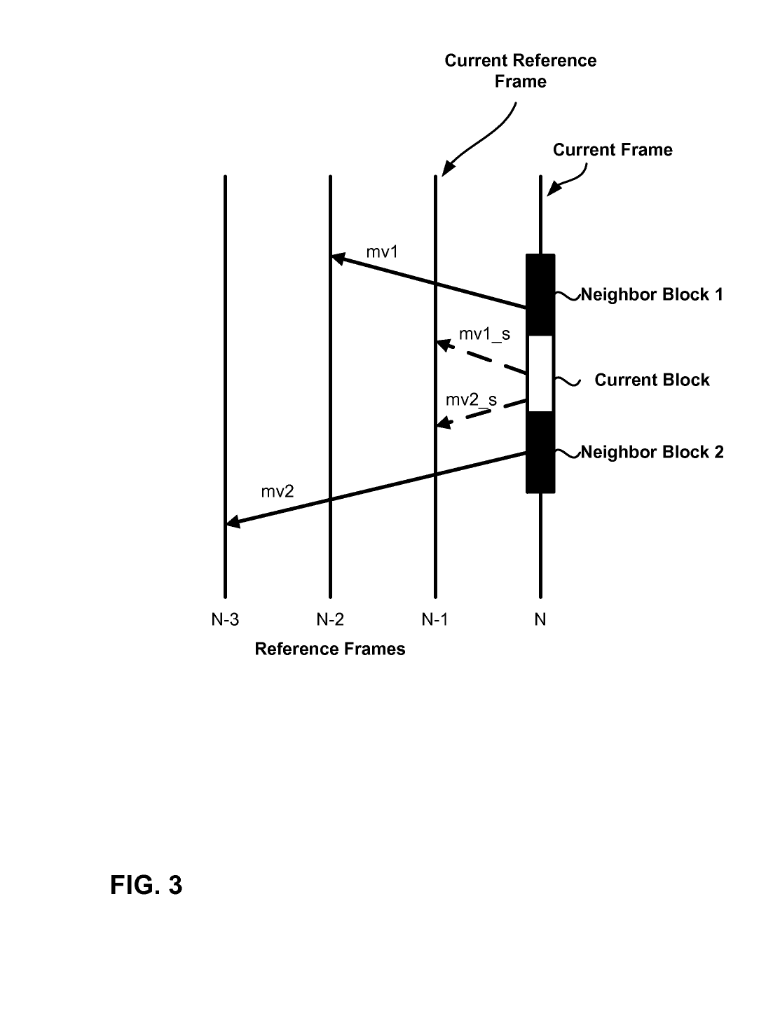

FIG. 3 is a graphical illustration of POC-based motion vector scaling. As shown in FIG. 3, the current block, based on the motion search, uses reference frame N−1 as the current reference frame. The candidate blocks for performing AMVP for the current block include neighbor block 1 and neighbor block 2. Neighbor block 1 has a motion vector (mv1) that points to reference frame N−2. Neighbor block 2 has a motion vector (mv2) that points to the reference frame N−3. If the current block were coded to use mv1 as the MVP, mv1 is first scaled to produce a motion vector (mv1_s) that points to the current reference frame (reference frame N−1). The POC distance between the current frame and reference frames N−1 and N−2 would be used in the equation above (i.e., td=2 and tb=1). Likewise, if the current block were coded to use mv2 as the MVP, mv2 is first scaled to produce a motion vector (mv2_s) that points to the current reference frame (reference frame N−1). The POC distance between the current frame and reference frames N−1 and N−2 would be used in the equation above (i.e., td=3 and tb=1). It should be noted that POC-based motion vector scaling may also be based on temporally subsequent frames (e.g., N+1, N+2, etc.), as well as temporally previous frames, as shown in FIG. 3. FIG. 3 is merely one example.

In previous video coding standard, like AVC, when a long-term reference picture is involved in derivation of a motion vector for temporal direct mode, motion vector scaling is not performed. The motion vector of the collocated block is used without scaling as the motion vector predictor (MVP) for a current block. In the JCTVC-G551 proposal to HEVC, I1-Koo Kim, et al., “Restriction on Motion Vector Scaling for Merge and AMVP, 7th Meeting: Geneva, CH, 21-30 November, 2011 (available from http://phenix.int-evry.fr/jct/doc_end_user/documents/7_Geneva/wg11/JCTVC-G551-v2.zip), it was proposed that, when the POC distance between the reference picture of the current prediction unit (PU) and the reference picture of the candidate PU (collocated PU or neighbor PU) is larger than a pre-defined threshold, motion vector scaling is not performed.

The above restrictions were applied because POC-based motion vector scaling generally relies on the assumption that motion between nearby frames (i.e., frames that have low POC distances from each other) is relatively linear. As such, a linear scaling algorithm as described above, generates an adequate approximation of reference to the current reference frame. This may not always be the case when the reference frame is a long-term reference picture (i.e., a picture potentially far in temporal distance from the current reference frame) or has a POC distance between reference pictures that is larger than a threshold.

However, these and other existing designs for motion vector scaling exhibit several drawbacks. In this first example discussed above, motion vector scaling is performed unless a long-term reference picture is involved. However, any reference picture may be marked as a long-term reference picture; thus, it is possible that motion vector scaling still provides better coding efficiency when a long-term reference is involved. In the second example described above, motion vector scaling is performed unless the POC distance between the reference picture of the current prediction unit (PU) and the reference picture of the candidate PU (collocated PU or neighbor PU) is larger than a pre-defined threshold. However, while a pre-defined threshold may be optimal for certain video sequences, it may be sub-optimal for other video sequences. For a certain view sequence, a pre-defined threshold may be optimal for certain video frames or certain regions in a particular frame in the video sequence, but may be sub-optimal for other frames or other regions in a particular frame. Furthermore, for a certain view sequence, a pre-defined threshold may be optimal for a certain frame rate, but sub-optimal for other frame rates.

In view of these drawbacks, this disclosure proposes techniques for motion vector scaling. In particular, this disclosure proposes that both an implicit motion vector scaling process (e.g., the POC-based motion vector scaling process described above), as well as an explicit motion vector scaling process (e.g., a motion vector scaling process using scaling weights) may be used to perform motion vector scaling. In particular, video encoder 20 may be configured to determine to use an implicit motion vector scaling process, an explicit motion vector scaling process, or no motion vector scaling process for blocks of video data. In this way, explicit motion vector scaling may still be performed in situations where implicit, POC-based motion vector scaling is disallowed (e.g., disallowed based on POC distance thresholds or long-term reference pictures). This disclosure also discloses example signaling methods for indicating the type of motion vector scaling used.

In one example of this disclosure, video encoder 20 is configured to signal a flag (e.g., named implicit_mv_scale_flag) in the encoded video bitstream (e.g., in a picture parameter set (PPS) syntax structure) with the following semantics. The implicit_mv_scale_flag equal to 1 specifies that implicit motion vector scaling (i.e., POC-based motion vector scaling) is enabled for all pictures referring to the PPS. The implicit_mv_scale_flag equal to 0 specifies that implicit motion vector scaling is disabled for all pictures referring to the PPS.

In this example, video encoder 20 is also configured to signal an additional flag (e.g., named explicit_mv_scale_flag), in the encoded video bitstream (e.g., in the picture parameter set (PPS) syntax structure) with the following semantics. The explicit_mv_scale_flag equal to 1 specifies that explicit motion vector scaling (e.g., motion vector scaling using explicit scaling weights) is enabled for all pictures referring to the PPS. The explicit_mv_scale_flag equal to 0 specifies that explicit motion vector scaling is disabled for all pictures referring to the PPS. If both implicit_mv_scale_flag and explicit_mv_scale_flag are equal to 0, no MV scaling is performed for all pictures referring to the PPS. In another example, if both implicit_mv_scale_flag and explicit_mv_scale_flag are equal to 0, it may be determined that implicit motion vector scaling is used for a slice when no motion vector scaling weight is signaled, and explicit motion vector scaling is used for a slice when motion vector scaling weights are signaled (e.g. in the slice header). Alternatively, in another example, it is disallowed to have both flags equal to 1.

Video encoder 20 may determine to utilize explicit motion vector scaling in situations where POC-based motion vector scaling is disallowed (e.g., when the POC distance is greater than a threshold, or when a long-term reference picture is used). Explicit motion vector scaling includes applying and signaling a calculated or predetermined scaling weight assigned to a particular reference picture to any motion vectors that point to that reference picture. A scaling weight may be determined by trying different possible values and choosing the one that yields the best or an acceptable (e.g., above a threshold) rate-distortion performance. In one example, video encoder 20 may be configured to determine whether to apply implicit, POC-based motion vector scaling, explicit motion vector scaling, or no motion vector scaling based on testing using a rate-distortion optimization. In other examples, the application of explicit motion vector scaling is limited to only situations where POC-based motion vector scaling is disallowed. In this example, testing through a rate-distortion optimization may be used to determine whether to apply explicit motion vector scaling or no motion vector scaling.

To reiterate, if implicit_my_scale_flag is equal to 1, explicit_my_scale_flag shall be equal to 0, and POC based MV scaling (similar to that used in HEVC WD5) is applied for all pictures referring to the PPS. Likewise, if explicit_my_scale_flag is equal to 1, implicit_my_scale_flag flag shall be equal to 0, and video encoder 20 is further configured to signal, e.g., in the slice header for a picture referring to this PPS, an indication of a scaling weight for each reference index value (or a set of reference index values). Herein, similarly as for weighted prediction, one particular reference picture can correspond to multiple reference index values, such that different weights can be applied in different regions in one reference picture. The indication of the scaling weight may be the scaling weight value itself, or an index that indicates a scaling weight known to both video encoder 20 and video decoder 30. For example, a set of scaling weights may be stored in a table or other data structure by video encoder 20 and/or video decoder 30, and accessed from the table using the index value, or computed based on the index value.

Upon receiving the flags, and possible indication of scaling weights, video decoder 30 may determine the type of motion vector scaling to perform (or not to perform) during the motion compensation process. In this way, video encoder 20 may be configured to selectively apply motion vector scaling, even in situations where POC-based motion vector scaling is disallowed, and to signal the type of scaling used to the video decoder.

In another example, rather than signalling two different one-bit flags (i.e., implicit_mv_scale_flag and explicit_mv_scale_flag), video encoder 20 may signal a two-bit syntax element (e.g., named mv_scale_idc) in the PPS. The value 0 for mv_scale_idc for specifies the same outcome as implicit_mv_scale_flag and explicit_mv_scale_flag both equal to 0 as described above (no MV scaling is performed). The value 1 for mv_scale_idc specifies the same outcome as implicit_mv_scale_flag equal to 1 and explicit_mv_scale_flag equal to 0 as described above (POC based MV scaling). The value 2 for mv_scale_idc specifies the same outcome as implicit_mv_scale_flag equal to 0 and explicit_mv_scale_flag equal to 1 as described above (weighted MV scaling). The value of 3 for mv_scale_idc need not be used, or may be used to signal another technique for MV scaling, or may be used to signal both implicit and explicit MV scaling methods are possible but which one is used for a slice depends on the presence of explicit MV scaling weights for the slice, e.g., in the slice header.

In another example of the disclosure, video encoder 20 may signal a flag (e.g., named mv_scale_flag) in the encoded video bitstream (e.g., in the picture parameter set (PPS) syntax) with the following semantics. The mv_scale_flag equal to 1 specifies that POC based motion vector scaling (similar to that used in HEVC WD5) is applied for all pictures referring to the PPS. The mv_scale_flag flag equal to 0 specifies that no motion vector scaling is performed for all pictures referring to the PPS.

In another example of the disclosure, video encoder 20 may signal a flag in the encoded video bitstream (e.g., in the slice header) with the following semantics. The flag equal to 1 specifies that POC based motion vector scaling (similar to that used in HEVC WD5) is applied for the picture. The flag equal to 0 specifies that no motion vector scaling is performed for the picture.

In another example of the disclosure, video encoder 20 may signal any of the above-described flags in the PPS syntax and in the slice header. The flag(s) in the slice header are only present when the value of the slice header flag is different from the value of the flag in the referred PPS. Otherwise, the semantics of the flags are the same as described above.

In another example of the disclosure, video encoder 20 may signal a flag (e.g., named pps_mv_scale_flag) in the encoded video bitstream (e.g., in the picture parameter set (PPS) syntax) with the following semantics. The pps_mv_scale_flag equal to 1 specifies that POC based motion vector scaling (similar that used in HEVC WD5) is applied for all pictures referring to the PPS. The pps_mv_scale_flag equal to 0 specifies that no motion vector scaling is performed for all pictures referring to the PPS.

When the above pps_mv_scale_flag flag is equal to 1, an additional flag (e.g., named sh_mv_scale_flag) may be signaled for each reference picture index in a reference picture list. If sh_mv_scale_flag is equal to 1 for a particular reference picture index in a reference picture list, POC based motion vector scaling (similar to that used in HEVC WD5) is applied when the reference picture index is considered as the target reference picture for the current picture. If sh_mv_scale_flag is equal to 0 for a particular reference picture index in a reference picture list, POC based motion vector scaling (similar to that used in HEVC WD5) is not applied when the reference picture index is considered as the target reference picture for the current picture.

In another example, if sh_mv_scale_flag is equal to 1 for a particular reference picture index in a reference picture list, POC based motion vector scaling (similar to that used in HEVC WD5) is applied when the reference picture index is considered as the picture containing the candidate block for the current picture. If sh_mv_scale_flag is equal to 0 for a particular reference picture index in a reference picture list, POC based motion vector scaling (similar to that used in HEVC WD5) is not applied when the reference picture index is considered as the picture containing the candidate block for the current picture.

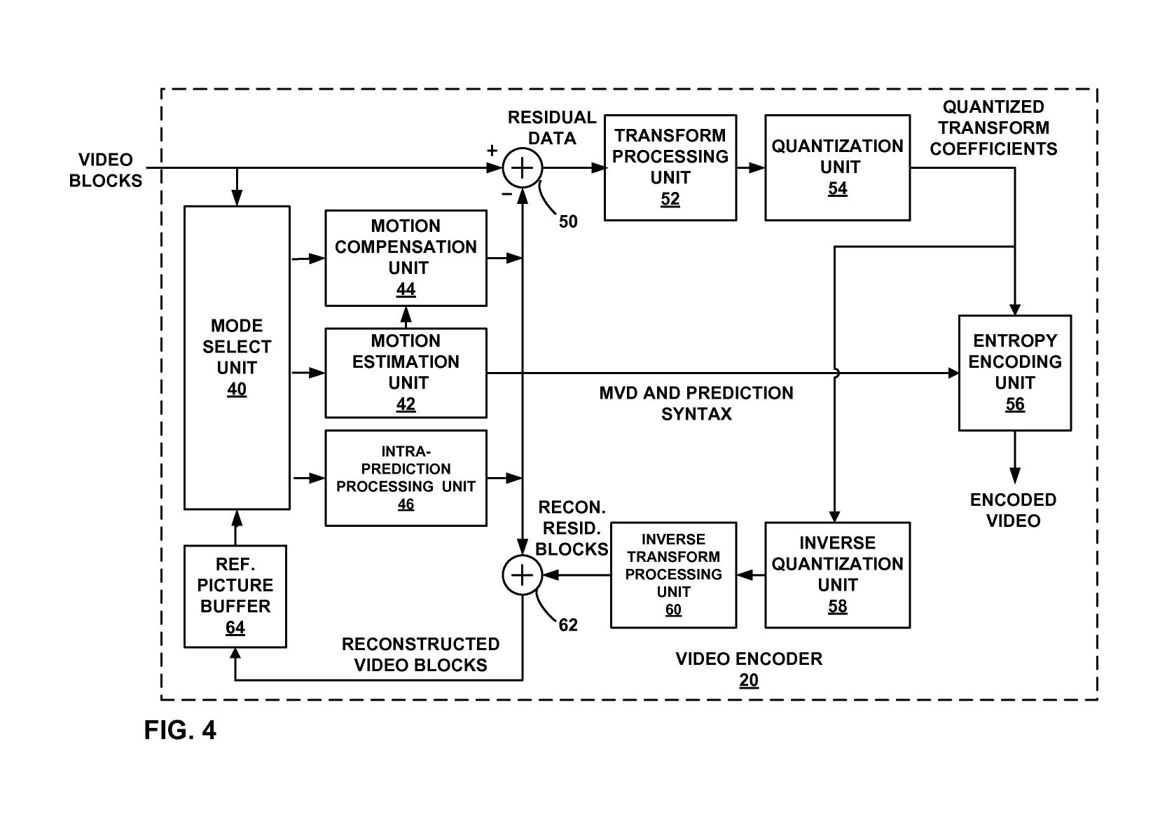

FIG. 4 is a block diagram illustrating an example of a video encoder 20 that may use techniques for motion vector scaling as described in this disclosure. The video encoder 20 will be described in the context of HEVC coding for purposes of illustration, but without limitation of this disclosure as to other coding standards or methods that may use motion vector scaling. The video encoder 20 may perform intra- and inter-coding of CUs within video frames. Intra-coding relies on spatial prediction to reduce or remove spatial redundancy in video data within a given video frame. Inter-coding relies on temporal prediction to reduce or remove temporal redundancy between a current frame and previously coded frames of a video sequence. Intra-mode (I-mode) may refer to any of several spatial-based video compression modes. Inter-modes such as uni-directional prediction (P-mode) or bi-directional prediction (B-mode) may refer to any of several temporal-based video compression modes.

As shown in FIG. 4, the video encoder 20 receives a current video block within a video frame to be encoded. In the example of FIG. 4, the video encoder 20 includes a motion compensation unit 44, a motion estimation unit 42, an intra-prediction processing unit 46, a reference picture buffer 64, a summer 50, a transform processing unit 52, a quantization unit 54, and an entropy encoding unit 56. The transform processing unit 52 illustrated in FIG. 4 is the unit that applies the actual transform or combinations of transform to a block of residual data, and is not to be confused with a block of transform coefficients, which also may be referred to as a transform unit (TU) of a CU. For video block reconstruction, the video encoder 20 also includes an inverse quantization unit 58, an inverse transform processing unit 60, and a summer 62. A deblocking filter (not shown in FIG. 4) may also be included to filter block boundaries to remove blockiness artifacts from reconstructed video. If desired, the deblocking filter would typically filter the output of the summer 62.

During the encoding process, the video encoder 20 receives a video frame or slice to be coded. The frame or slice may be divided into multiple video blocks, e.g., largest coding units (LCUs). The motion estimation unit 42 and the motion compensation unit 44 perform inter-predictive coding of the received video block relative to one or more blocks in one or more reference frames to provide temporal compression. The intra-prediction processing unit 46 may perform intra-predictive coding of the received video block relative to one or more neighboring blocks in the same frame or slice as the block to be coded to provide spatial compression.

The mode select unit 40 may select one of the coding modes, intra or inter, e.g., based on error (i.e., distortion) results for each mode, and provides the resulting intra- or inter-predicted block (e.g., a prediction unit (PU)) to the summer 50 to generate residual block data and to the summer 62 to reconstruct the encoded block for use in a reference frame. Summer 62 combines the predicted block with inverse quantized, inverse transformed data from inverse transform processing unit 60 for the block to reconstruct the encoded block, as described in greater detail below. Some video frames may be designated as I-frames, where all blocks in an I-frame are encoded in an intra-prediction mode. In some cases, the intra-prediction processing unit 46 may perform intra-prediction encoding of a block in a P- or B-frame, e.g., when the motion search performed by the motion estimation unit 42 does not result in a sufficient prediction of the block.

The motion estimation unit 42 and the motion compensation unit 44 may be highly integrated, but are illustrated separately for conceptual purposes. Motion estimation (or motion search) is the process of generating motion vectors, which estimate motion for video blocks. A motion vector, for example, may indicate the displacement of a prediction unit in a current frame relative to a reference sample of a reference frame. The motion estimation unit 42 calculates a motion vector for a prediction unit of an inter-coded frame by comparing the prediction unit to reference samples of a reference frame stored in the reference picture buffer 64. A reference sample may be a block that is found to closely match the block of the CU including the PU being coded in terms of pixel difference, which may be determined by sum of absolute difference (SAD), sum of squared difference (SSD), or other difference metrics. The reference sample may occur anywhere within a reference frame or reference slice, and not necessarily at a block (e.g., coding unit) boundary of the reference frame or slice. In some examples, the reference sample may occur at a fractional pixel position.

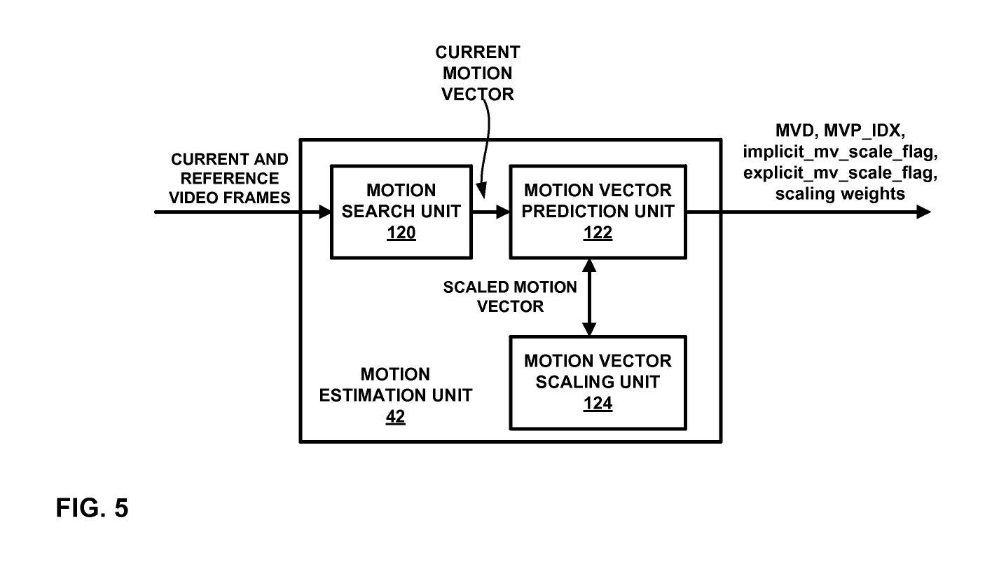

According to the examples of this disclosure, motion estimation unit 42 may perform motion vector scaling using one or motion vector scaling processes. FIG. 5 is a block diagram illustrating an example motion estimation unit 42 of video encoder 20 configured to perform the techniques of this disclosure. As shown in FIG. 5, motion estimation unit 42 may include motion search unit 120, motion vector prediction unit 122, and motion vector scaling unit 124.

Consistent with the techniques described above, motion search unit 120 may be configured to perform a motion search process for blocks in the current frame using other, temporally different reference frames. Based on the motion search, motion search unit 120 output a current motion vector for the block of video data being coded. Motion vector prediction unit 122 uses the current motion vector to perform a motion vector prediction process. As described above, the motion vector prediction process may be AMVP, whereby candidate motion vectors from neighboring blocks of the current blocks are used as a motion vector predictor (MVP). In cases where motion vector prediction unit 122 selects an MVP that points to a different reference frame than the current motion vector, the MPV may be scaled.

In the case where the MPV is to be scaled, motion vector scaling unit 124 performs a scaling process. Motion vector scaling unit 124 may determine a motion vector scaling process and scale the MVP in accordance with the techniques described above. The scaled MVP may then be used by motion vector prediction unit 122 to calculate a motion vector difference (MVD) between the current motion vector and the scaled motion vector. In addition to outputting the MVD and the index of the candidate block having the MVP (mvp_idx), motion estimation unit 42 may also signal one or more flags to indicate the motion vector scaling processes being used. As one example, motion estimation unit 42 may signal the implicit_mv_scale_flag and the explicit_mv_scale_flag as defined above. In addition, in an example where explicit motion vector scaling is used, motion estimation unit 42 may further signal an indication of scaling weights, e.g., by signaling weight values or index values used to determine weight values.

It should be noted that FIG. 5 shows motion vector prediction unit 122 and motion vector scaling unit 124 as separate hardware units. However, in some examples, the functionality of those units may be combined into a single unit.

Returning to FIG. 4, the motion estimation unit 42 sends the calculated motion vector to the entropy encoding unit 56 and the motion compensation unit 44. The portion of the reference frame identified by a motion vector may be referred to as a reference sample. The motion compensation unit 44 may calculate a prediction value for a prediction unit of a current CU, e.g., by retrieving the reference sample identified by a motion vector for the PU.

The intra-prediction processing unit 46 may intra-predict the received block, as an alternative to inter-prediction performed by the motion estimation unit 42 and the motion compensation unit 44. The intra-prediction processing unit 46 may predict the received block relative to neighboring, previously coded blocks, e.g., blocks above, above and to the right, above and to the left, or to the left of the current block, assuming a left-to-right, top-to-bottom encoding order for blocks. The intra-prediction processing unit 46 may be configured with a variety of different intra-prediction modes. For example, the intra-prediction processing unit 46 may be configured with a certain number of directional prediction modes, e.g., thirty-four directional prediction modes, based on the size of the CU being encoded.

The intra-prediction processing unit 46 may select an intra-prediction mode by, for example, calculating error values for various intra-prediction modes and selecting a mode that yields the lowest error value. Directional prediction modes may include functions for combining values of spatially neighboring pixels and applying the combined values to one or more pixel positions in a PU. Once values for all pixel positions in the PU have been calculated, the intra-prediction processing unit 46 may calculate an error value for the prediction mode based on pixel differences between the PU and the received block to be encoded. The intra-prediction processing unit 46 may continue testing intra-prediction modes until an intra-prediction mode that yields an acceptable error value is discovered. The intra-prediction processing unit 46 may then send the PU to the summer 50.

The video encoder 20 forms a residual block by subtracting the prediction data calculated by the motion compensation unit 44 or the intra-prediction processing unit 46 from the original video block being coded. The summer 50 represents the component or components that perform this subtraction operation. The residual block may correspond to a two-dimensional matrix of pixel difference values, where the number of values in the residual block is the same as the number of pixels in the PU corresponding to the residual block. The values in the residual block may correspond to the differences, i.e., error, between values of co-located pixels in the PU and in the original block to be coded. The differences may be chroma or luma differences depending on the type of block that is coded.

The transform processing unit 52 may form one or more transform units (TUs) from the residual block. The transform processing unit 52 selects a transform from among a plurality of transforms. The transform may be selected based on one or more coding characteristics, such as block size, coding mode, or the like. The transform processing unit 52 then applies the selected transform to the TU, producing a video block comprising a two-dimensional array of transform coefficients.

The transform processing unit 52 may send the resulting transform coefficients to the quantization unit 54. The quantization unit 54 may then quantize the transform coefficients. The entropy encoding unit 56 may then perform a scan of the quantized transform coefficients in the matrix according to a scanning mode. This disclosure describes the entropy encoding unit 56 as performing the scan. However, it should be understood that, in other examples, other processing units, such as the quantization unit 54, could perform the scan.

Once the transform coefficients are scanned into the one-dimensional array, the entropy encoding unit 56 may apply entropy coding such as CAVLC, CABAC, syntax-based context-adaptive binary arithmetic coding (SBAC), Probability Interval Partitioning Entropy (PIPE), or another entropy coding methodology to the coefficients.

To perform CAVLC, the entropy encoding unit 56 may select a variable length code for a symbol to be transmitted. Codewords in VLC may be constructed such that relatively shorter codes correspond to more likely symbols, while longer codes correspond to less likely symbols. In this way, the use of VLC may achieve a bit savings over, for example, using equal-length codewords for each symbol to be transmitted.

To perform CABAC, the entropy encoding unit 56 may select a context model to apply to a certain context to encode symbols to be transmitted. The context may relate to, for example, whether neighboring values are non-zero or not. The entropy encoding unit 56 may also entropy encode syntax elements, such as the signal representative of the selected transform.

Following the entropy coding by the entropy encoding unit 56, the resulting encoded video may be transmitted to another device, such as the video decoder 30, or archived for later transmission or retrieval.

In some cases, the entropy encoding unit 56 or another unit of the video encoder 20 may be configured to perform other coding functions, in addition to entropy coding. For example, the entropy encoding unit 56 may be configured to determine coded block pattern (CBP) values for CU's and PU's. Also, in some cases, the entropy encoding unit 56 may perform run length coding of coefficients.

The inverse quantization unit 58 and the inverse transform processing unit 60 apply inverse quantization and inverse transformation, respectively, to reconstruct the residual block in the pixel domain, e.g., for later use as a reference block. The motion compensation unit 44 may calculate a reference block by adding the residual block to a predictive block of one of the frames of the reference picture buffer 64. The motion compensation unit 44 may also apply one or more interpolation filters to the reconstructed residual block to calculate sub-integer pixel values for use in motion estimation. The summer 62 adds the reconstructed residual block to the motion compensated prediction block produced by the motion compensation unit 44 to produce a reconstructed video block for storage in the reference picture buffer 64. The reconstructed video block may be used by the motion estimation unit 42 and the motion compensation unit 44 as a reference block to inter-code a block in a subsequent video frame.

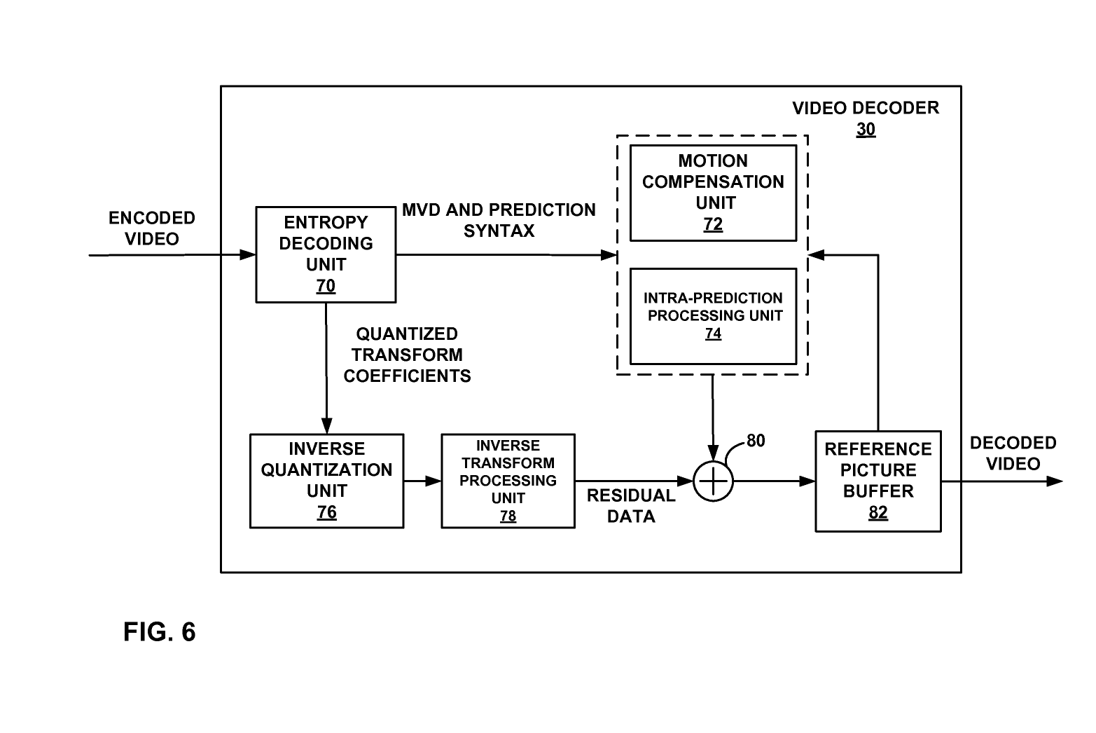

FIG. 6 is a block diagram illustrating an example of a video decoder 30, which decodes an encoded video sequence. In the example of FIG. 6, the video decoder 30 includes an entropy decoding unit 70, a motion compensation unit 72, an intra-prediction processing unit 74, an inverse quantization unit 76, an inverse transform processing unit 78, a reference picture buffer 82 and a summer 80. The video decoder 30 may, in some examples, perform a decoding pass generally reciprocal to the encoding pass described with respect to the video encoder 20 (see FIG. 4).

The entropy decoding unit 70 performs an entropy decoding process on the encoded bitstream to retrieve a one-dimensional array of transform coefficients. The entropy decoding process used depends on the entropy coding used by the video encoder 20 (e.g., CABAC, CAVLC, etc.). The entropy coding process used by the encoder may be signaled in the encoded bitstream or may be a predetermined process.

In some examples, the entropy decoding unit 70 (or the inverse quantization unit 76) may scan the received values using a scan mirroring the scanning mode used by the entropy encoding unit 56 (or the quantization unit 54) of the video encoder 20. Although the scanning of coefficients may be performed in the inverse quantization unit 76, scanning will be described for purposes of illustration as being performed by the entropy decoding unit 70. In addition, although shown as separate functional units for ease of illustration, the structure and functionality of the entropy decoding unit 70, the inverse quantization unit 76, and other units of the video decoder 30 may be highly integrated with one another.

The inverse quantization unit 76 inverse quantizes, i.e., de-quantizes, the quantized transform coefficients provided in the bitstream and decoded by the entropy decoding unit 70. The inverse quantization process may include a conventional process, e.g., similar to the processes proposed for HEVC or defined by the H.264 decoding standard. The inverse quantization process may include use of a quantization parameter QP calculated by the video encoder 20 for the CU to determine a degree of quantization and, likewise, a degree of inverse quantization that should be applied. The inverse quantization unit 76 may inverse quantize the transform coefficients either before or after the coefficients are converted from a one-dimensional array to a two-dimensional array.

The inverse transform processing unit 78 applies an inverse transform to the inverse quantized transform coefficients. In some examples, the inverse transform processing unit 78 may determine an inverse transform based on signaling from the video encoder 20, or by inferring the transform from one or more coding characteristics such as block size, coding mode, or the like. In some examples, the inverse transform processing unit 78 may determine a transform to apply to the current block based on a signaled transform at the root node of a quadtree for an LCU including the current block. Alternatively, the transform may be signaled at the root of a TU quadtree for a leaf-node CU in the LCU quadtree. In some examples, the inverse transform processing unit 78 may apply a cascaded inverse transform, in which inverse transform processing unit 78 applies two or more inverse transforms to the transform coefficients of the current block being decoded.

The intra-prediction processing unit 74 may generate prediction data for a current block of a current frame based on a signaled intra-prediction mode and data from previously decoded blocks of the current frame.

The motion compensation unit 72 may retrieve the motion vector, motion prediction direction and reference index from the encoded bitstream. The reference prediction direction indicates whether the inter-prediction mode is uni-directional (e.g., a P frame) or bi-directional (a B frame). The reference index indicates which reference frame the candidate motion vector is based on.

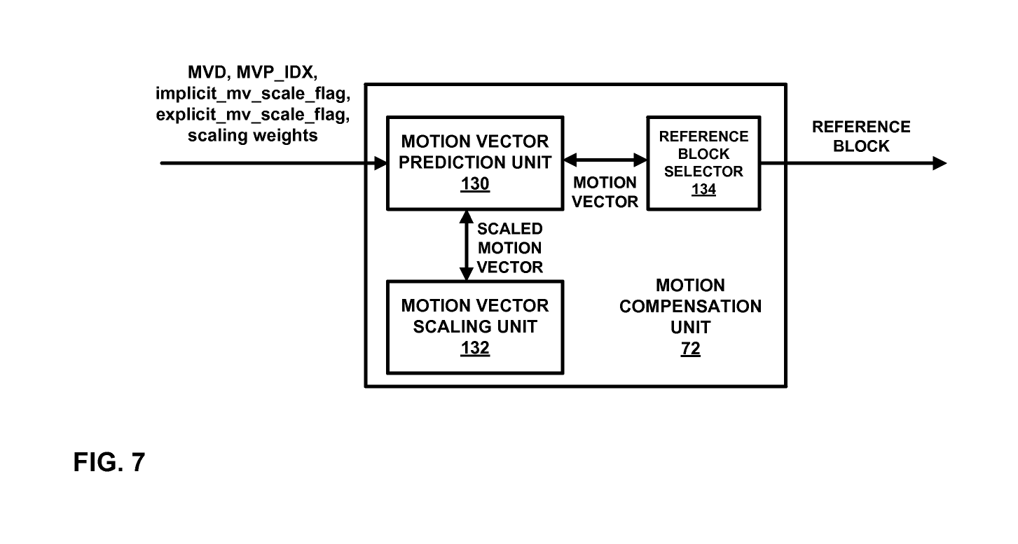

According to the examples of this disclosure, motion compensation unit 72 may perform motion vector scaling using one or motion vector scaling processes. FIG. 7 is a block diagram illustrating an example motion compensation unit 72 of video decoder 30 configured to perform the techniques of this disclosure. As shown in FIG. 7, motion compensation unit 72 may include motion vector prediction unit 130, motion vector scaling unit 132, and reference block selector 134.

Consistent with the techniques described above, motion vector prediction unit 130 may be configured to determine a motion vector for a currently decoded block based on a motion vector difference (MVD) and an MPV index (mvp_idx) when operating in AMVP mode. As described above, the motion vector prediction process may be AMVP, whereby candidate motion vectors from neighboring blocks of the current blocks are used as a motion vector predictor (MVP).

Motion vector prediction unit 130 may also receive one or more flags (e.g., the implicit_mv_scale_flag and the explicit_mv_scale_flag as defined above) and scaling weights that indicate how the MVP was scaled in the encoder. Based on theses flags, motion vector scaling unit 132 performs a scaling process to scale the MVP so that it may be accurately combined with the MVD to produce the motion vector for the current block. In the case of implicit scaling, a POC-based scaling technique is used. In the case of explicit scaling, the MPV is scaled according to the scaling weights indicated in the encoded bitstream.

Based on the motion vector output by motion vector prediction unit 130, as well as reference index also signaled in the encoded bitstream, reference block selector 134 selects the reference block that will be added to the residual data (see FIG. 6) to produce the decoded block.

It should be noted that FIG. 7 shows motion vector prediction unit 130 and motion vector scaling unit 132 as separate hardware units. However, in some examples, the functionality of those units may be combined into a single unit.

Returning to FIG. 6, based on the retrieved motion prediction direction, reference frame index, and motion vector, the motion compensation unit produces a motion compensated block for the current block. These motion compensated blocks essentially recreate the predictive block used to produce the residual data.

The motion compensation unit 72 may produce the motion compensated blocks, possibly performing interpolation based on interpolation filters. Identifiers for interpolation filters to be used for motion estimation with sub-pixel precision may be included in the syntax elements. The motion compensation unit 72 may use interpolation filters as used by the video encoder 20 during encoding of the video block to calculate interpolated values for sub-integer pixels of a reference block. The motion compensation unit 72 may determine the interpolation filters used by the video encoder 20 according to received syntax information and use the interpolation filters to produce predictive blocks.

Additionally, the motion compensation unit 72 and the intra-prediction processing unit 74, in an HEVC example, may use some of the syntax information (e.g., provided by a quadtree) to determine sizes of LCUs used to encode frame(s) of the encoded video sequence. The motion compensation unit 72 and the intra-prediction processing unit 74 may also use syntax information to determine split information that describes how each CU of a frame of the encoded video sequence is split (and likewise, how sub-CUs are split). The syntax information may also include modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence.

The summer 80 combines the residual blocks with the corresponding prediction blocks generated by the motion compensation unit 72 or the intra-prediction processing unit 74 to form decoded blocks. If desired, a deblocking filter may also be applied to filter the decoded blocks in order to remove blockiness artifacts. The decoded video blocks are then stored in the reference picture buffer 82 (sometimes called a decoded picture buffer (DPB), which provides reference blocks for subsequent motion compensation and also produces decoded video for presentation on a display device (such as the display device 32 of FIG. 1).

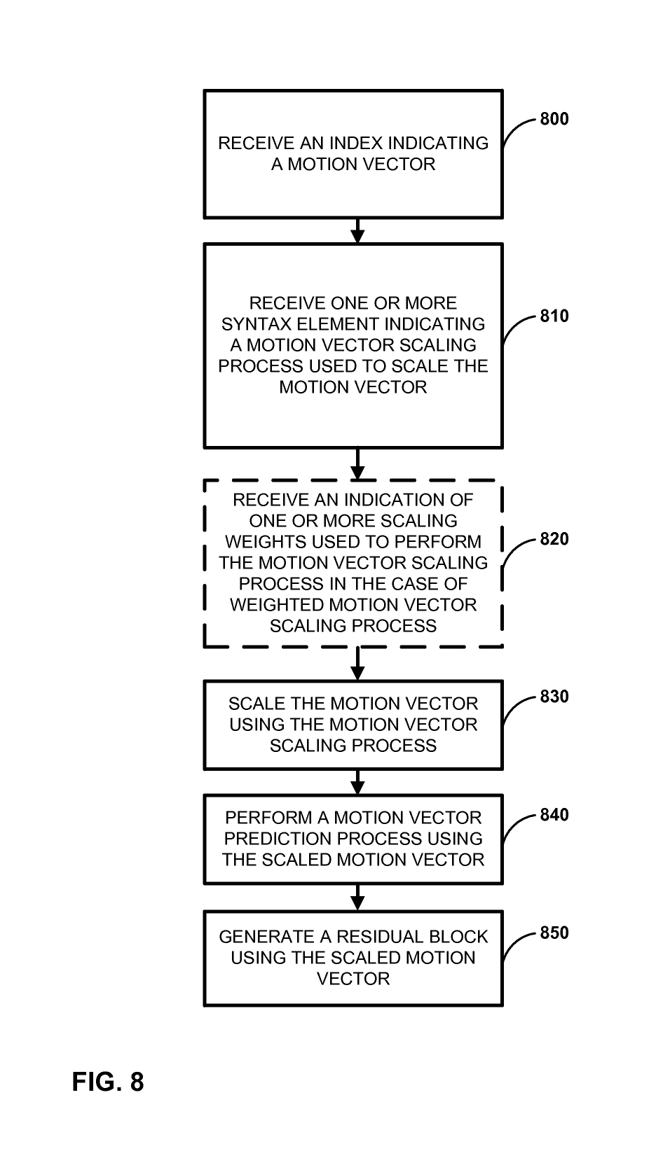

FIG. 8 is a flowchart of an example decoding method according to the techniques of this disclosure. The techniques of FIG. 8 may be implemented by one or more hardware units of video decoder 30. In one example of the disclosure, video decoder 30 may be configured receive an index indicating a motion vector (800) and receive one or more syntax elements indicating a motion vector scaling process, among a plurality of different motion vector scaling processes, used to scale the motion vector (810).

In one example of the disclosure, the plurality of motion vector scaling processes includes no motion vector scaling, picture order count based motion vector scaling process, and a weighted motion vector scaling process.

In one example, receiving the one or more syntax elements comprises receiving an implicit motion vector scaling flag, when equal to a particular value, indicating that the motion vector scaling process is a picture order count based motion vector scaling process. As such, the step of scaling the motion vector using the motion vector scaling process (830), would include scaling the motion vector using the picture order count based motion vector scaling process.

In another example, receiving the one or more syntax elements comprises receiving an explicit motion vector scaling flag indicating that the motion vector scaling process is a weighted motion vector scaling process. In this case, video decoder 30 may be further configured to receive an indication of one or more scaling weights used to perform the motion vector scaling process. As such, the step of scaling the motion vector using the motion vector scaling process (830), would include scaling the motion vector using the weighted motion vector scaling process and the indication of one or more scaling weights.

In one example, the indication is an index identifying a motion vector scaling weight. In another example, the indication includes one or more values of the motion vector scaling weights. In another example, receiving the indication of one or more motion vector scaling weights comprises receiving a motion vector scaling weight for each of a plurality of reference index values. In yet another example, receiving the indication of one or more motion vector scaling weights comprises receiving a motion vector scaling weight for each of a plurality of sets of reference index values.

The one or more syntax elements of step 810 may be received in different data structures. In one example, video decoder 30 is configured to receive the one or more syntax elements in a picture parameter set. In another example, video decoder 30 is configured to receive the one or more syntax elements in a slice header.

In another example, video decoder 30 is configured to receive a picture parameter set syntax element in a picture parameter set, and receive a slice header syntax element in a slice header, in the case that the slice header syntax element has a different value than the picture parameter set syntax element. In another example, video decoder 30 is configured to receive a picture parameter set syntax element in a picture parameter set, the picture parameter set syntax element indicating that either the motion vector scaling process is picture order count based motion vector scaling or that no motion vector scaling process is applied, and when the picture parameter set syntax element indicates picture order count based motion vector scaling, receive a reference picture syntax element for each of a plurality of reference pictures. In another example, the reference picture syntax element equal to a particular value indicates that picture order count motion vector scaling is used for its respective reference picture. In another example, the one or more syntax elements are two-bit syntax elements.

Video decoder 30 may also be further configured to perform a motion vector prediction process on a block of video data associated with the received index using the scaled motion vector (840), and generate a residual block based on the video block and the scaled motion vector (850).

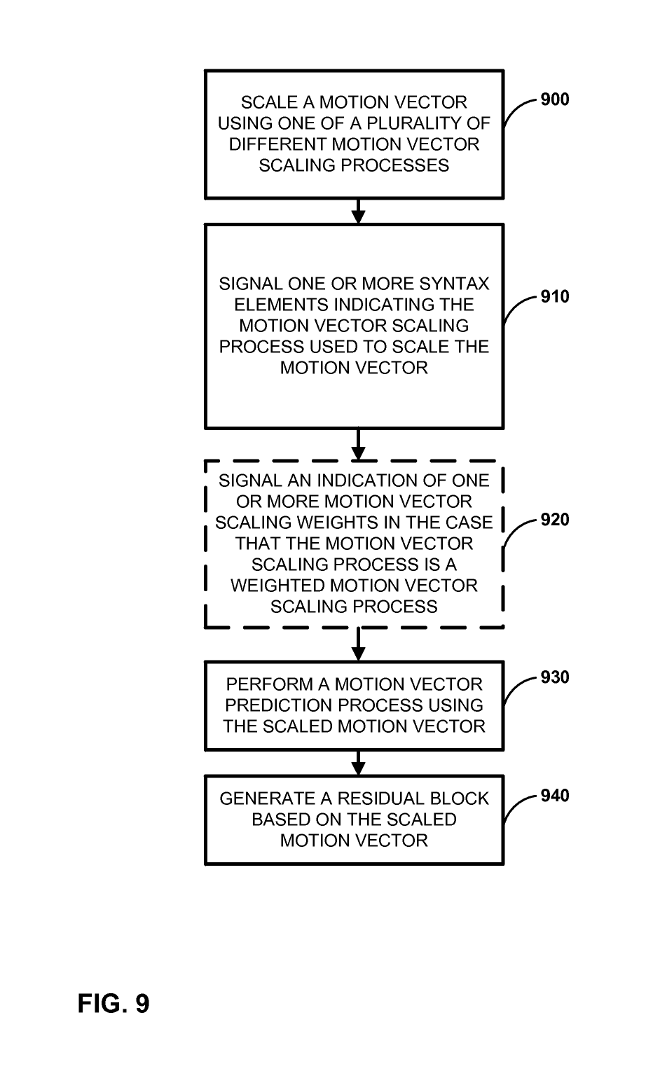

FIG. 9 is a flowchart of an example encoding method according to the techniques of this disclosure. The techniques of FIG. 9 may be implemented by one or more hardware units of video encoder 20. In one example of the disclosure, video encoder 20 may be configured to scale a motion vector using one of a plurality of different motion vector scaling processes (900), and signal one or more syntax elements indicating the motion vector scaling process used to scale the motion vector (910).

In one example, the plurality of motion vector scaling processes includes no motion vector scaling, a picture order count based motion vector scaling process, and a weighted motion vector scaling process.

In one example, video encoder 20 may be configured to scale the motion vector using the picture order count based motion vector scaling process, and video encoder may be configured to signal an implicit motion vector scaling flag, equaling a particular value, indicating that the motion vector scaling process is the picture order count based motion vector scaling process.

In another example, video encoder 20 may be configured to scale the motion vector using the weighted motion vector scaling process. In this example, video encoder 20 may be further configured to signal an explicit motion vector scaling flag indicating that the motion vector scaling process is the weighted motion vector scaling process, signal an indication of one or more motion vector scaling weights used to perform the motion vector scaling process (920).

In one example, the indication is an index to a set of motion vector scaling weights. In another example, the indication includes one or more values of the motion vector scaling weights. In another example, video encoder 20 may be configured to signal a motion vector scaling weight for each of a plurality of reference index values. In another example, video encoder 20 may be configured to signal a motion vector scaling weight for each of a plurality of sets of reference index values.

The one or more syntax elements of step 910 may be signaled in different data structures. In one example, video encoder 20 may be configured to signal the one or more syntax elements in a picture parameter set. In another example, video encoder 20 may be configured to signal the one or more syntax elements in a slice header.

In another example, video encoder 20 may be configured to signal a picture parameter set syntax element in a picture parameter set, and signal a slice header syntax element in a slice header in the case that the slice header syntax element has a different value than the picture parameter set syntax element. In another example, video encoder 20 may be configured to signal a picture parameter set syntax element in a picture parameter set, the picture parameter set syntax element indicating that either the motion vector scaling process is picture order count based motion vector scaling or that no motion vector scaling process is applied, and when the picture parameter set syntax element indicates picture order count based motion vector scaling, signal a reference picture syntax element for each of a plurality of reference pictures. In another example, the reference picture syntax element equal to a particular value indicates that picture order count motion vector scaling is used for its respective reference picture. In another example, the one or more syntax elements are two-bit syntax elements.

Video encoder 20 may be further configured to perform a motion vector prediction process on a video block using the scaled motion vector (930), and generate a residual block based on the video block and the scaled motion vector (940).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding a motion vector for video coding, the method comprising:
receiving an index indicating a motion vector;
receiving one or more syntax elements indicating a motion vector scaling process, among a plurality of different motion vector scaling processes, used to scale the motion vector; and
scaling the motion vector using the motion vector scaling process.

2. The method of claim 1, wherein the plurality of motion vector scaling processes includes no motion vector scaling, picture order count based motion vector scaling process, and a weighted motion vector scaling process.

3. The method of claim 2, wherein receiving one or more syntax elements comprises receiving an implicit motion vector scaling flag, when equal to a particular value, indicating that the motion vector scaling process is a picture order count based motion vector scaling process, and
wherein scaling the motion vector comprises scaling the motion vector using the picture order count based motion vector scaling process.

4. The method of claim 2, the method further comprising:
receiving an indication of one or more scaling weights used to perform the motion vector scaling process,
wherein receiving one or more syntax elements comprises receiving an explicit motion vector scaling flag indicating that the motion vector scaling process is a weighted motion vector scaling process, and
wherein scaling the motion vector comprises scaling the motion vector using the weighted motion vector scaling process and the indication of one or more scaling weights.

5. The method of claim 4, wherein the indication is an index identifying a motion vector scaling weight.

6. The method of claim 4, wherein the indication includes one or more values of the motion vector scaling weights.

7. The method of claim 4, wherein receiving the indication of one or more motion vector scaling weights comprises receiving a motion vector scaling weight for each of a plurality of reference index values.

8. The method of claim 4, wherein receiving the indication of one or more motion vector scaling weights comprises receiving a motion vector scaling weight for each of a plurality of sets of reference index values.

9. The method of claim 1, wherein receiving the one or more syntax elements comprises receiving the one or more syntax elements in a picture parameter set.

10. The method of claim 1, wherein receiving the one or more syntax elements comprises receiving the one or more syntax elements in a slice header.

11. The method of claim 1, wherein receiving the one or more syntax elements comprises receiving a picture parameter set syntax element in a picture parameter set, and receiving a slice header syntax element in a slice header in the case that the slice header syntax element has a different value than the picture parameter set syntax element.

12. The method of claim 1, wherein receiving the one or more syntax elements comprises receiving a picture parameter set syntax element in a picture parameter set, the picture parameter set syntax element indicating that either the motion vector scaling process is picture order count based motion vector scaling or that no motion vector scaling process is applied, and when the picture parameter set syntax element indicates picture order count based motion vector scaling, receiving a reference picture syntax element for each of a plurality of reference pictures.

13. The method of claim 12, wherein the reference picture syntax element equal to a particular value indicates that picture order count motion vector scaling is used for its respective reference picture.

14. The method of claim 1, wherein the one or more syntax elements are two-bit syntax elements.

15. The method of claim 1, further comprising:
performing a motion vector prediction process on a block of video data associated with the received index using the scaled motion vector; and
generating a residual block based on the video block and the scaled motion vector.

16. A method of encoding a motion vector for video encoding, the method comprising:
scaling a motion vector using one of a plurality of different motion vector scaling processes; and
signaling one or more syntax elements indicating the motion vector scaling process used to scale the motion vector.

17. The method of claim 16, wherein the plurality of motion vector scaling processes includes no motion vector scaling, a picture order count based motion vector scaling process, and a weighted motion vector scaling process.

18. The method of claim 17, wherein scaling the motion vector comprises scaling the motion vector using the picture order count based motion vector scaling process, and
wherein signaling one or more syntax elements comprises signaling an implicit motion vector scaling flag, equaling a particular value, indicating that the motion vector scaling process is the picture order count based motion vector scaling process.

19. The method of claim 18, wherein scaling the motion vector comprises scaling the motion vector using the weighted motion vector scaling process, and
wherein signaling one or more syntax elements comprises signaling an explicit motion vector scaling flag indicating that the motion vector scaling process is the weighted motion vector scaling process, and wherein the method further comprises signaling an indication of one or more motion vector scaling weights used to perform the motion vector scaling process.

20. The method of claim 19, wherein the indication is an index to a set of motion vector scaling weights.

21. The method of claim 19, wherein the indication includes one or more values of the motion vector scaling weights.

22. The method of claim 19, wherein signaling the indication of one or more motion vector scaling weights comprises signaling a motion vector scaling weight for each of a plurality of reference index values.

23. The method of claim 19, wherein signaling the indication of one or more motion vector scaling weights comprises signaling a motion vector scaling weight for each of a plurality of sets of reference index values.

24. The method of claim 16, wherein signaling the one or more syntax elements comprises signaling the one or more syntax elements in a picture parameter set.

25. The method of claim 16, wherein signaling the one or more syntax elements comprises signaling the one or more syntax elements in a slice header.

26. The method of claim 16, wherein signaling the one or more syntax elements comprises signaling a picture parameter set syntax element in a picture parameter set, and signaling a slice header syntax element in a slice header in the case that the slice header syntax element has a different value than the picture parameter set syntax element.

27. The method of claim 16, wherein signaling the one or more syntax elements comprises signaling a picture parameter set syntax element in a picture parameter set, the picture parameter set syntax element indicating that either the motion vector scaling process is picture order count based motion vector scaling or that no motion vector scaling process is applied, and when the picture parameter set syntax element indicates picture order count based motion vector scaling, signaling a reference picture syntax element for each of a plurality of reference pictures.

28. The method of claim 27, wherein the reference picture syntax element equal to a particular value indicates that picture order count motion vector scaling is used for its respective reference picture.

29. The method of claim 16, wherein the one or more syntax elements are two-bit syntax elements.

30. The method of claim 16, further comprising:
performing a motion vector prediction process on a video block using the scaled motion vector; and
generating a residual block based on the video block and the scaled motion vector.

31. An apparatus configured to decode a motion vector for video coding, the apparatus comprising:
a video decoder configured to:
receive an index indicating a motion vector;
receive one or more syntax elements indicating a motion vector scaling process, among a plurality of different motion vector scaling processes, used to scale the motion vector; and
scale the motion vector using the motion vector scaling process.

32. The apparatus of claim 31, wherein the plurality of motion vector scaling processes includes no motion vector scaling, picture order count based motion vector scaling process, and a weighted motion vector scaling process.

33. The apparatus of claim 32, wherein the video decoder is further configured to receive an implicit motion vector scaling flag, when equal to a particular value, indicating that the motion vector scaling process is a picture order count based motion vector scaling process, and
wherein the video decoder is further configured to scale the motion vector using the picture order count based motion vector scaling process.

34. The apparatus of claim 32, wherein the video decoder is further configured to:
receive an indication of one or more scaling weights used to perform the motion vector scaling process,
wherein the video decoder is further configured to receive an explicit motion vector scaling flag indicating that the motion vector scaling process is a weighted motion vector scaling process, and
wherein the video decoder is further configured to scale the motion vector using the weighted motion vector scaling process and the indication of one or more scaling weights.

35. The apparatus of claim 34, wherein the indication is an index identifying a motion vector scaling weight.

36. The apparatus of claim 34, wherein the indication includes one or more values of the motion vector scaling weights.

37. The apparatus of claim 34, wherein the video decoder is further configured to receive a motion vector scaling weight for each of a plurality of reference index values.

38. The apparatus of claim 34, wherein the video decoder is further configured to receive a motion vector scaling weight for each of a plurality of sets of reference index values.

39. The apparatus of claim 31, wherein the video decoder is further configured to receive the one or more syntax elements in a picture parameter set.

40. The apparatus of claim 31, wherein the video decoder is further configured to receive the one or more syntax elements in a slice header.

41. The apparatus of claim 31, wherein the video decoder is further configured to receive a picture parameter set syntax element in a picture parameter set, and receive a slice header syntax element in a slice header in the case that the slice header syntax element has a different value than the picture parameter set syntax element.

42. The apparatus of claim 31, wherein the video decoder is further configured to receive a picture parameter set syntax element in a picture parameter set, the picture parameter set syntax element indicating that either the motion vector scaling process is picture order count based motion vector scaling or that no motion vector scaling process is applied, and when the picture parameter set syntax element indicates picture order count based motion vector scaling, receive a reference picture syntax element for each of a plurality of reference pictures.

43. The apparatus of claim 42, wherein the reference picture syntax element equal to a particular value indicates that picture order count motion vector scaling is used for its respective reference picture.

44. The apparatus of claim 31, wherein the one or more syntax elements are two-bit syntax elements.

45. The apparatus of claim 31, wherein the video decoder is further configured to:
perform a motion vector prediction process on a block of video data associated with the received index using the scaled motion vector; and
generate a residual block based on the video block and the scaled motion vector.

46. An apparatus configured to encode a motion vector for video encoding, the apparatus comprising:
a video encoder configured to:
scale a motion vector using one of a plurality of different motion vector scaling processes; and
signal one or more syntax elements indicating the motion vector scaling process used to scale the motion vector.

47. The apparatus of claim 46, wherein the plurality of motion vector scaling processes includes no motion vector scaling, a picture order count based motion vector scaling process, and a weighted motion vector scaling process.

48. The apparatus of claim 47, wherein the video encoder is further configured to scale the motion vector using the picture order count based motion vector scaling process, and
wherein the video encoder is further configured to signal an implicit motion vector scaling flag, equaling a particular value, indicating that the motion vector scaling process is the picture order count based motion vector scaling process.

49. The apparatus of claim 48, wherein the video encoder is further configured to scale the motion vector using the weighted motion vector scaling process, and
wherein the video encoder is further configured to signal an explicit motion vector scaling flag indicating that the motion vector scaling process is the weighted motion vector scaling process, and wherein the video encoder is further configured to signal an indication of one or more motion vector scaling weights used to perform the motion vector scaling process.

50. The apparatus of claim 49, wherein the indication is an index to a set of motion vector scaling weights.

51. The apparatus of claim 49, wherein the indication includes one or more values of the motion vector scaling weights.

52. The apparatus of claim 49, wherein the video encoder is further configured to signal a motion vector scaling weight for each of a plurality of reference index values.

53. The apparatus of claim 49, wherein the video encoder is further configured to signal a motion vector scaling weight for each of a plurality of sets of reference index values.

54. The apparatus of claim 46, wherein the video encoder is further configured to signal the one or more syntax elements in a picture parameter set.

55. The apparatus of claim 46, wherein the video encoder is further configured to signal the one or more syntax elements in a slice header.

56. The apparatus of claim 46, wherein the video encoder is further configured to signal a picture parameter set syntax element in a picture parameter set, and signal a slice header syntax element in a slice header in the case that the slice header syntax element has a different value than the picture parameter set syntax element.

57. The apparatus of claim 46, wherein the video encoder is further configured to signal a picture parameter set syntax element in a picture parameter set, the picture parameter set syntax element indicating that either the motion vector scaling process is picture order count based motion vector scaling or that no motion vector scaling process is applied, and when the picture parameter set syntax element indicates picture order count based motion vector scaling, signal a reference picture syntax element for each of a plurality of reference pictures.

58. The apparatus of claim 57, wherein the reference picture syntax element equal to a particular value indicates that picture order count motion vector scaling is used for its respective reference picture.

59. The apparatus of claim 46, wherein the one or more syntax elements are two-bit syntax elements.

60. The apparatus of claim 46, wherein the video encoder is further configured to:
perform a motion vector prediction process on a video block using the scaled motion vector; and
generate a residual block based on the video block and the scaled motion vector.

61. An apparatus configured to decode a motion vector for video coding, the apparatus comprising:
means for receiving an index indicating a motion vector;
means for receiving one or more syntax elements indicating a motion vector scaling process, among a plurality of different motion vector scaling processes, used to scale the motion vector; and
means for scaling the motion vector using the motion vector scaling process.

62. An apparatus configured to encode a motion vector for video encoding, the apparatus comprising:
means for scaling a motion vector using one of a plurality of different motion vector scaling processes; and
means for signaling one or more syntax elements indicating the motion vector scaling process used to scale the motion vector.

63. A computer-readable storage medium storing instructions that, when executed, cause one or more processors of a device configured to decode video data to:
receive an index indicating a motion vector;
receive one or more syntax elements indicating a motion vector scaling process, among a plurality of different motion vector scaling processes, used to scale the motion vector; and
scale the motion vector using the motion vector scaling process.

64. A computer-readable storage medium storing instructions that, when executed, cause one or more processors of a device configured to encode video data to:
scale a motion vector using one of a plurality of different motion vector scaling processes; and
signal one or more syntax elements indicating the motion vector scaling process used to scale the motion vector.
